(19) United States
(12) Patent Application Publication
(10) Pub. No.: US 2026/0203728 A1
(43) Pub. Date: Jul. 16, 2026

(54) SYSTEMS AND METHODS FOR RECYCLING CONSUMER ELECTRONIC DEVICES

(71) Applicant: ecoATM, LLC, San Diego, CA (US)

(72) Inventors: John Beane, San Diego, CA (US); Babak Forutanpour, San Diego, CA (US)

(21) Appl. No.: 19/402,884

(22) Filed: Nov. 26, 2025

Related U.S. Application Data
(63) Continuation of application No. 17/393,168, filed on Aug. 3, 2021, now Pat. No. 12,541,745.
Application No. 17/393,168 is a continuation of application No. 14/967,183, filed on Dec. 11, 2015, now abandoned.

(51) Int. Cl. G06Q 10/30; G06Q 30/02; G07F 7/06; H04M 1/24; H04W 24/00

(52) U.S. Cl. CPC G06Q 10/30; G06Q 30/0278; G07F 7/06; H04W 24/00; H04M 1/24; Y02W 30/82; Y02W 90/00

(57) ABSTRACT

Systems and associated methods for recycling and performing other processes with consumer electronic devices are described herein. In various embodiments, the present technology includes systems and methods for enabling, e.g., a retailer to identify and evaluate a used or pre-owned consumer electronic device, such as a mobile phone, laptop, etc. to facilitate purchasing the device from the consumer. In some embodiments, the present technology includes an evaluator input device and an evaluator hub device that together evaluate a device and facilitate its purchase and recycling. Various other aspects of the present technology are described herein.

### CROSS-REFERENCE TO RELATED APPLICATION

This application is a continuation of U.S. patent application Ser. No. 17/393,168, filed Aug. 3, 2021, which is a continuation of U.S. patent application Ser. No. 14/967,183 filed on Dec. 11, 2015, both of which are hereby incorporated by reference in their entirety.

### TECHNICAL FIELD

The present disclosure is directed generally to systems and methods for recycling consumer electronic devices and, more particularly, to systems and methods for identification, evaluation, exchange, return, and/or purchase of consumer electronic devices.

### BACKGROUND

Consumer electronic devices, such as mobile phones, laptop computers, notebooks, tablets, MP3 players, etc., are ubiquitous. Over 300 million desk-based and notebook computers shipped in 2013, and for the first time the number of tablet computers shipped exceeded laptops. In addition, there are over 6 billion mobile devices in use in the world and the number of these devices is growing rapidly with more than 1.8 billion mobile phones being sold in 2013 alone. By 2017 it is expected that there will be more mobile devices in use than there are people on the planet. Part of the reason for the rapid growth in the number of mobile phones and other electronic devices is the rapid pace at which these devices evolve, and the increased usage of such devices in third world countries.

As a result of the rapid pace of development, a relatively high percentage of electronic devices are replaced every year as consumers continually upgrade their electronic devices to obtain the latest features. According to the U.S. Environmental Protection Agency, the U.S. alone disposes of over 370 million mobile phones, PDAS, tablets, and other electronic devices every year. Millions of other outdated or broken electronic devices are simply tossed into junk drawers or otherwise kept until a suitable disposal solution arises.

Although many electronic device retailers now offer mobile phone trade-in or buyback programs, many old devices still end up in landfills or are improperly disassembled and disposed of in developing countries. Unfortunately, however, electronic devices typically contain substances that can be harmful to the environment, such as arsenic, lithium, cadmium, copper, lead, mercury and zinc. If not properly disposed of, these toxic substances can seep into groundwater from decomposing landfills and contaminate the soil with potentiality harmful consequences for humans and the environment.

As an alternative to retailer trade-in or buyback programs, consumers can now recycle and/or sell their used mobile phones and other electronic devices using self-service kiosks located in malls or other publically accessible areas. Such kiosks are operated by ecoATM, Inc., the assignee of the present application, and are disclosed in, for example, U.S. Pat. Nos. 8,463,646, 8,423,404, 8,239,262, 8,200,533, 8,195,511, and 7,881,965; and in U.S. patent application numbers Ser. Nos. 12/573,089, 12/727,624, 13/113,497, 12/785,465, 13/017,560, 13/438,924, 13/753,539, 13/658,825, 13/733,984, 13/705,252, 13/487,299 13/492,835, 13/562,292, 13/658,828, 13/693,032, 13/792,030, 13/794,814, 13/794,816, 13/862,395 and 13/913,408, each of which is incorporated herein by reference in its entirety.

Certain retail establishments and other locations may be reluctant to provide a full-sized kiosk for recycling electronic devices due to the relatively large footprint of the kiosk. Accordingly, there continues to be a need for expanding the means available to consumers for recycling or reselling mobile phones and other consumer electronic devices. Simplifying the recycling and reselling process, enhancing the consumer experience, and discouraging fraud can incentivize consumers to dispose of their old electronic devices in an efficient and environmentally conscientious way.

### BRIEF DESCRIPTION OF THE DRAWINGS

FIG. 1 illustrates an embodiment of a suitable computing environment for implementing various aspects of the present technology.

FIG. 2 is a block diagram illustrating various components typically incorporated in computing systems and other devices on which the present technology can be implemented.

FIG. 3 is a schematic diagram of a suitable distributed computing environment for implementing various aspects of the present technology.

FIG. 4 is a flow diagram of a routine for pricing a target device for recycling in accordance with embodiments of the present technology.

FIG. 5 is a flow diagram of another routine for pricing a target device for recycling in accordance with embodiments of the present technology.

FIG. 6 is a flow diagram of a routine for identifying and pricing a target device for recycling in accordance with embodiments of the present technology.

### DETAILED DESCRIPTION

The following disclosure describes various embodiments of systems and methods for recycling and/or other processing of electronic devices. For example, the following describes various embodiments of systems enabling retail stores to evaluate mobile devices for recycling and repurchase. Retail stores-such as mobile carrier stores-typically include clerks who operate tablets or other computing devices for completing transactions with customers. In some embodiments of the present technology, a retail tablet can run a software application (“app”) that enables a clerk to evaluate a customer's mobile device for potential recycling.

For example, the app can direct the clerk to obtain images and/or video of the customer's mobile device using the tablet's built-in camera or other imaging device. The images and/or video can then be transmitted via the app to remote servers where the images and/or video are analyzed either automatically (e.g., using machine vision techniques) or manually (e.g., using remote individuals to view the images and/or video and assess the condition of the mobile device based on the images and/or video). The customer's mobile device can additionally be electrically connected to a device (e.g., an “evaluator hub” device) located within the retail store, for example via a USB cable or other electrical connector. The evaluator hub can then electrically interrogate and evaluate the customer's mobile device. Together the electrical and visual evaluations are utilized to determine an appropriate price to offer the customer in exchange for the customer's mobile device. Some embodiments of this recycling system can be particularly advantageous in that it can make use of tablets or other such handheld devices already in use by store clerks without the need to provide specialized hardware for such handheld devices. In conjunction with the clerk's handheld devices, a stationary evaluator hub device can be provided with hardware and software configured to electrically connect with and evaluate the customer's mobile device. Together, the clerk's handheld device and the evaluator hub device can evaluate and determine an appropriate price for the customer's mobile device.

The various embodiments of the systems and methods described herein for recycling electronic devices can be particularly useful for retailers. For example, such systems may enable retailers to offer recycling of electronic devices without the need for specially trained staff members. Additionally, certain state and federal laws may provide incentives for retailers to participate in “takeback” programs that require manufacturers to assist with recycling of electronic devices. Manufacturers often offer warranties or other guarantees that may require receiving and evaluating electronic devices returned by customers. In some instances, retailers may offer buyback programs in order to promote sales of new products, for example offering a customer $50 towards the purchase of a new mobile phone if the customer brings in an old mobile phone for recycling. In these and other instances, the consumer's electronic device can be returned at a convenient location using various embodiments of the evaluator devices described in detail herein. These embodiments enable the electronic devices to be evaluated, inspected, binned, and compensation to be dispensed to the user. The retailer or other establishment hosting the recycling system may then coordinate with manufacturers or electronics recyclers to pick up the collected electronic devices.

The disclosed technology also includes the disclosures of U.S. patent application Ser. No. 14/498,763, titled “METHODS AND SYSTEMS FOR PRICING AND PERFORMING OTHER PROCESSES ASSOCIATED WITH RECYCLING MOBILE PHONES AND OTHER ELECTRONIC DEVICES,” attorney docket number 111220-8024.US00, filed by the applicant on Sep. 26, 2014; U.S. patent application Ser. No. 14/500,739, titled “MAINTAINING SETS OF CABLE COMPONENTS USED FOR WIRED ANALYSIS, CHARGING, OR OTHER INTERACTION WITH PORTABLE ELECTRONIC DEVICES,” attorney docket number 111220-8025.US00, filed by the applicant on Sep. 29, 2014; U.S. provisional application No. 62/059,129, titled “WIRELESS-ENABLED KIOSK FOR RECYCLING CONSUMER DEVICES,” attorney docket number 111220-8022.US00, filed by the applicant on Oct. 2, 2014; U.S. provisional application No. 62/059,132, titled “APPLICATION FOR DEVICE EVALUATION AND OTHER PROCESSES ASSOCIATED WITH DEVICE RECYCLING,” attorney docket number 111220-8023.US00, filed by the applicant on Oct. 2, 2014; U.S. patent application Ser. No. 14/506,449, titled “SYSTEM FOR ELECTRICALLY TESTING MOBILE DEVICES AT A CONSUMER-OPERATED KIOSK, AND ASSOCIATED DEVICES AND METHODS,” attorney docket number 111220-8035.US00, filed by the applicant on Oct. 3, 2014; U.S. provisional application No. 62/073,840, titled “SYSTEMS AND METHODS FOR RECYCLING CONSUMER ELECTRONIC DEVICES,” attorney docket number 111220-8027.US00, filed by the applicant on Oct. 31, 2014; U.S. provisional application number 62/073,847, titled “METHODS AND SYSTEMS FOR FACILITATING PROCESSES ASSOCIATED WITH INSURANCE SERVICES AND/OR OTHER SERVICES FOR ELECTRONIC DEVICES,” attorney docket number 111220-8028.US00, filed by the applicant on Oct. 31, 2014; U.S. provisional application No. 62/090,855, titled “METHODS AND SYSTEMS FOR PROVIDING INFORMATION REGARDING COUPONS/PROMOTIONS AT KIOSKS FOR RECYCLING MOBILE PHONES AND OTHER ELECTRONIC DEVICES,” attorney docket number 111220-8031.US00, filed by the applicant on Dec. 11, 2014; U.S. patent application Ser. No. 14/568,051, titled “METHODS AND SYSTEMS FOR IDENTIFYING MOBILE PHONES AND OTHER ELECTRONIC DEVICES,” attorney docket number 111220-8033.US00, filed by the applicant on Dec. 11, 2014; U.S. provisional application No. 62/091,426, titled “SYSTEMS AND METHODS FOR RECYCLING CONSUMER ELECTRONIC DEVICES,” attorney docket number 111220-8037.US00, filed by the applicant on Dec. 12, 2014; U.S. patent application Ser. No. 14/598,469, titled “METHODS AND SYSTEMS FOR DYNAMIC PRICING AND PERFORMING OTHER PROCESSES ASSOCIATED WITH RECYCLING MOBILE PHONES AND OTHER ELECTRONIC DEVICES,” attorney docket number 111220-8034.US00, filed by the applicant on Jan. 16, 2015; U.S. patent application Ser. No. 14/660,768, titled “SYSTEMS AND METHODS FOR INSPECTING MOBILE DEVICES AND OTHER CONSUMER ELECTRONIC DEVICES WITH A LASER,” attorney docket number 111220-8030.US00, filed by the applicant on Mar. 17, 2015; U.S. patent application Ser. No. 14/663,331, titled “DEVICE RECYCLING SYSTEMS WITH FACIAL RECOGNITION,” attorney docket number 111220-8029.US00, filed by the applicant on Mar. 19, 2015; U.S. provisional application No. 62/169,072, titled “METHODS AND SYSTEMS FOR VISUALLY EVALUATING ELECTRONIC DEVICES,” attorney docket number 111220-8041.US00, filed by the applicant on Jun. 1, 2015; U.S. provisional application No. 62/202,330, titled “METHODS AND SYSTEMS FOR INSPECTING MOBILE DEVICES AND OTHER CONSUMER ELECTRONIC DEVICES WITH ROBOTIC ACTUATION,” attorney docket number 111220-8026.US00, filed by the applicant on Aug. 7, 2015; U.S. provisional application number 62/221,510, titled “METHODS AND SYSTEMS FOR RECORDING INTERACTIONS WITH A SYSTEM FOR PURCHASING MOBILE PHONES AND OTHER ELECTRONIC DEVICES,” attorney docket number 111220-8032.US00, filed by the applicant on Sep. 21, 2015; U.S. patent application number Ser. No. 14/873,158, titled “WIRELESS-ENABLED KIOSK FOR RECYCLING CONSUMER DEVICES,” attorney docket number 111220-8022.US01, filed by the applicant on Oct. 1, 2015; U.S. patent application Ser. No. 14/873,145, titled “APPLICATION FOR DEVICE EVALUATION AND OTHER PROCESSES ASSOCIATED WITH DEVICE RECYCLING,” attorney docket number 111220-8023.US01, filed by the applicant on Oct. 1, 2015; U.S. patent application Ser. No. 14/925,357, titled “SYSTEMS AND METHODS FOR RECYCLING CONSUMER ELECTRONIC DEVICES,” attorney docket number 111220-8027.US01, filed by the applicant on Oct. 28, 2015; and U.S. patent application Ser. No. 14/925,375, titled “METHODS AND SYSTEMS FOR FACILITATING PROCESSES ASSOCIATED WITH INSURANCE SERVICES AND/OR OTHER SERVICES FOR ELECTRONIC DEVICES,” attorney docket number 111220-8028.US01, filed by the applicant on Oct. 28, 2015, each of which is incorporated herein by reference in its entirety. All of the patents and patent applications listed above are commonly owned by the applicant of the present application, and they along with any other patents or patent applications identified herein are incorporated herein by reference in their entireties.

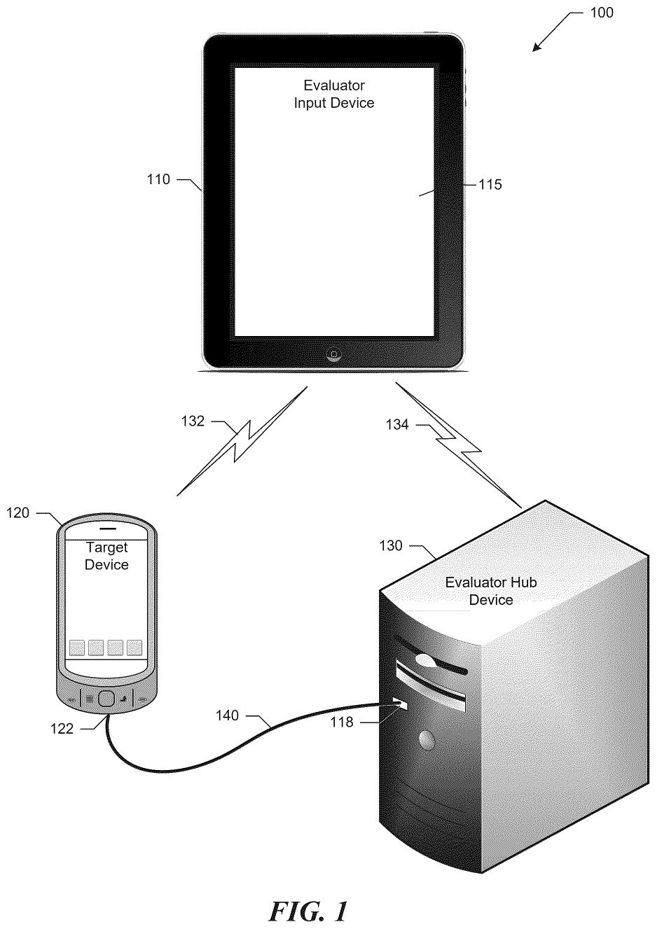

Certain details are set forth in the following description and in FIGS. 1-6 to provide a thorough understanding of various embodiments of the present technology. In other instances, well-known structures, materials, operations and/or systems often associated with smartphones and other handheld devices, consumer electronic devices, computer hardware, software, and network systems, etc. are not shown or described in detail in the following disclosure to avoid unnecessarily obscuring the description of the various embodiments of the present technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the present technology. Indeed, certain terms may even be emphasized below; however, any terminology intended to be interpreted in any restricted manner will be specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 illustrates an embodiment of an environment 100 in which various aspects of the present technology can be implemented. The environment 100 includes a first electronic device (e.g., an evaluator input device 110), a second electronic device (e.g., a target device 120), and a third electronic device (e.g., an evaluator hub device 130). In the illustrated embodiment, the evaluator input device 110 is depicted as a handheld electronic device such as a tablet computer, the target device 120 is depicted as a handheld electronic device such as a mobile phone, and the evaluator hub device 130 is depicted as a conventional computing device such as a personal computer or server. However, in other embodiments, the evaluator input device 110, the target device 120, and/or the evaluator hub device 130 can be any manner of electronic device in accordance with the functions thereof described herein. For example, the evaluator input device 110 could be, e.g., a notebook, desktop computer, or wearable device; the target device 120 could be, e.g., a tablet, a laptop, a handheld gaming device, a media player, etc.; and the evaluator hub device 130 could be, e.g., a mobile phone, tablet, laptop, or wearable device. Although many embodiments of the present technology are described herein in the context of mobile phones, aspects of the present technology are not limited to mobile phones and generally apply to other consumer electronic devices. Such devices include, as non-limiting examples, all manner of mobile phones; smartphones; handheld devices; personal digital assistants (PDAs); MP3 or other digital music players; tablet, notebook, ultrabook and laptop computers; e-readers; all types of cameras; GPS devices; set-top boxes and other media players; VoIP phones; universal remote controls; speakers; headphones; wearable computers; larger consumer electronic devices, such as desktop computers, TVs, projectors, DVRs, game consoles, Blu-Ray Disc™ players, printers, network attached storage devices, etc.; as well smaller electronic devices such as Google® Glass™, smartwatches (e.g., the Apple Watch™, Android Wear™ devices such as the Moto 360®, or the Pebble Steel™ watch), fitness bands, thumb drives, wireless hands-free devices; unmanned aerial vehicles; etc.

In the illustrated embodiment of FIG. 1, the target device 120 includes a communication interface (e.g., a connector port 122 and/or a wireless transceiver (not shown)), the evaluator input device 110 includes a communication interface (e.g., wireless transceiver (not shown)), and the evaluator hub device 130 similarly includes a communication interface (e.g., a connector port 118).

In this embodiment, the evaluator input device 110 can be electrically connected to the target device 120 and the evaluator hub device 130 via wireless connections 132 and 134, respectively, between the respective device transceivers, such as a Wi-Fi or Bluetooth network or an NFC link. In certain embodiments, the evaluator input device 110 can be electrically connected to the evaluator hub device 130 via a wired connection. The target device 120 can be electrically connected to the evaluator hub device 130 via a wired connection 140, such as a USB, Ethernet, or Lightning cable connected between the device connector ports 118 and 122. A display screen 115 of the evaluator input device 110 can display information, such as textual information, indicating that the evaluator input device 110 has identified the target device 120, an image representing the target device 120, and/or icons or buttons enabling the user to select various options or actions such as confirming the correct identification of the target device 120, pricing the target device 120, saving the target device 120 in a list of devices, etc. In some embodiments, the evaluator input device 110 and the evaluator hub device 130 can be the same machine, for example a laptop or tablet computer. Such a laptop or computer may be used by a local evaluator to provide input regarding the target device 120 and can also be electrically connected to the target device 120 (e.g., via wired connection 140) for electrical evaluation of the target device 120.

As described in detail below, the present technology enables a clerk, assistant, or a person at a retail store or other such premises to evaluate and recycle an individual's mobile phone or other such device.

For example, the evaluator input device 110 and the evaluator hub device 130 can be located in a retail store or other such location. A customer can bring the target device 120 into the retail store to recycle the target device 120. A clerk or other individual can utilize the evaluator input device 110 and the evaluator hub device 130 to obtain information about the target device 120 via the wireless connection 132 and/or the wired connection 140, and utilize the information to facilitate recycling and/or other processing of the target device 120. The term “processing” is used herein for ease of reference to generally refer to all manner of services and operations that may be performed on, with, or otherwise in relation to a target device. Such services and operations can include, for example, selling, reselling, recycling, donating, exchanging, identifying, evaluating, pricing, auctioning, decommissioning, transferring data from or to, reconfiguring, refurbishing, etc. mobile phones and other electronic devices. The term “recycling” is used herein for ease of reference to generally refer to selling and/or purchasing, reselling, exchanging, donating and/or receiving, etc. electronic devices. For example, owners may elect to sell their used electronic devices, and the electronic devices can be recycled for resale, reconditioning, repair, recovery of salvageable components, environmentally conscious disposal, etc.

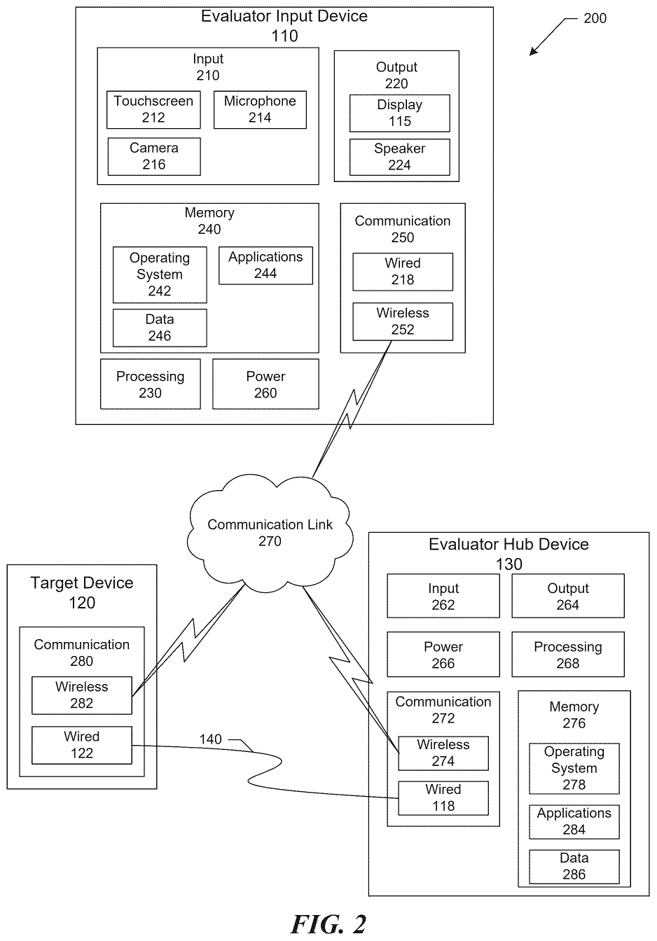

FIG. 2 is a block diagram showing some of the components 200 typically incorporated in computing systems and other devices on which the present technology can be implemented. In the illustrated embodiment, the evaluator input device 110 includes a processing component 230 that controls operation of the evaluator input device 110 in accordance with computer-readable instructions stored in memory 240. The processing component 230 may include any logic processing unit, such as one or more central processing units (CPUs), graphics processing units (GPUs), digital signal processors (DSPs), application-specific integrated circuits (ASICs), etc. The processing component 230 may be a single processing unit or multiple processing units in an electronic device or distributed across multiple devices. Aspects of the present technology can be embodied in a special purpose computing device or data processor that is specifically programmed, configured, or constructed to perform one or more of the computer-executable instructions explained in detail herein. Aspects of the present technology can also be practiced in distributed computing environments in which functions or modules are performed by remote processing devices that are linked through a communications network, such as a local area network (LAN), wide area network (WAN), or the Internet. In a distributed computing environment, modules can be located in both local and remote memory storage devices.

The processing component 230 is connected to memory 240, which can include a combination of temporary and/or permanent storage, and both read-only memory (ROM) and writable memory (e.g., random access memory or RAM), writable non-volatile memory such as flash memory or other solid-state memory, hard drives, removable media, magnetically or optically readable discs, nanotechnology memory, biological memory, and so forth. As used herein, memory does not include a transitory propagating signal per se. The memory 240 includes data storage that contains programs, software, and information, such as an operating system 242, application programs 244, and data 246. Evaluator input device 110 operating systems can include, for example, Windows®, Linux®, Android™, iOS®, and/or an embedded real-time operating system. The application programs 244 and data 246 can include software and databases configured to control evaluator input device 110 components, process target device 120 information and data (to, e.g., evaluate device make, model, condition, pricing, etc.), communicate and exchange data and information with remote computers and other devices, etc.

The evaluator input device 110 can further include input components 210 that receive input from user interactions and provide input to the processor 230, typically mediated by a hardware controller that interprets the raw signals received from the input device and communicates the information to the processor 230 using a known communication protocol. Examples of an input component 210 include a keyboard (with physical or virtual keys), a pointing device (such as a mouse, dial, or eye tracking device), a touchscreen 212 that detects contact events when it is touched by a user, a microphone 214 that receives audio input, and a camera 216 for still photograph and/or video capture. The evaluator input device 110 can also include various other input components 210 such as GPS or other location determination sensors, motion sensors, wearable input devices with accelerometers (e.g. wearable glove-type input devices), biometric sensors (e.g., fingerprint sensors), light sensors, card readers (e.g., magnetic stripe readers or memory card readers) or the like.

The processor 230 can also be connected to one or more various output components 220, e.g., directly or via a hardware controller. The output devices can include a display 115 on which text and graphics are displayed. The display 115 can be, for example, an LCD, LED, or OLED display screen (such as a desktop computer screen, handheld device screen, or television screen), an e-ink display, a projected display (such as a heads-up display device), and/or a display integrated with a touchscreen 212 that serves as an input device as well as an output device that provides graphical and textual visual feedback to the user. The output devices can also include a speaker 224 for playing audio signals, haptic feedback devices for tactile output such as vibration, etc. In some implementations, the speaker 224 and the microphone 214 are implemented by a combined audio input-output device.

In the illustrated embodiment, the evaluator input device 110 further includes one or more communication components 250. The communication components can include, for example, a wireless transceiver 252 (e.g., one or more of a Wi-Fi transceiver; Bluetooth transceiver; near-field communication (NFC) device; wireless modem or cellular radio utilizing GSM, CDMA, 3G and/or 4G technologies; etc.) and/or a wired network connection 218 (e.g., one or more of an Ethernet port, cable modem, FireWire cable, Lightning connector, universal serial bus (USB) port, etc.). The communication components 250 are suitable for communication between the evaluator input device 110 and other local and/or remote computing devices, e.g., the target device 120 and/or the evaluator hub device 130, directly via a wired or wireless peer-to-peer connection and/or indirectly via the communication link 270 (which can include the Internet, a public or private intranet, a local or extended Wi-Fi network, cell towers, the plain old telephone system (POTS), etc.). For example, the wireless transceiver 252 of the evaluator input device 110 can connect to the wireless transceiver 282 of the target device 120 and/or the wireless transceiver 274 of the evaluator hub device 130 via the wireless connection. The evaluator input device 110 further includes power 260, which can include battery power and/or facility power for operation of the various electrical components associated with the evaluator input device 110.

The evaluator hub device 130 can include several components similar to those in the evaluator input device 110. In the illustrated embodiment, the evaluator hub device 130 includes a processing component 268 that controls operation of the evaluator hub device 130 in accordance with computer-readable instructions stored in memory 276. The processing component 268 may be any logic processing unit, such as one or more central processing units (CPUs), graphics processing units (GPUs), digital signal processors (DSPs), application-specific integrated circuits (ASICs), etc. The processing component 268 may be a single processing unit or multiple processing units in an electronic device or distributed across multiple devices. The processing component 268 is connected to memory 276, which includes data storage that contains programs, software, and information, such as an operating system 278, application programs 284, and data 286. The operating system 278 can include, for example, Windows®, Linux®, Android™, iOS®, and/or an embedded real-time operating system. The application programs 284 and data 286 can include software and databases configured to control evaluator hub device 130 components, process target device 120 and/or evaluator input device 110 information and data (to, e.g., evaluate device make, model, condition, pricing, etc.), communicate and exchange data and information with remote computers and other devices, etc.

The evaluator hub device 130 can include input components 262, such as a keyboard (with physical or virtual keys), a pointing device (such as a mouse, joystick, dial, or eye tracking device), a touchscreen, a microphone, and a camera for still photograph and/or video capture. The evaluator hub device 130 can also include various other input components 262 such as GPS or other location determination sensors, motion sensors, wearable input devices with accelerometers (e.g. wearable glove-type input devices), biometric sensors (e.g., fingerprint sensors), light sensors, card readers (e.g., magnetic stripe readers or memory card readers) and the like.

The processor 268 can also be connected to one or more various output components 264, e.g., directly or via a hardware controller. The output devices can include a display such as an LCD, LED, or OLED display screen (such as a desktop computer screen, handheld device screen, or television screen), an e-ink display, a projected display (such as a heads-up display device), and/or a display integrated with a touchscreen that serves as an input device as well as an output device that provides graphical and textual visual feedback to the user. The output devices can also include a speaker for playing audio signals, haptic feedback devices for tactile output such as vibration, etc.

In the illustrated embodiment, evaluator hub device 130 further includes one or more communication components 272. The communication components can include, for example, a wireless transceiver 274 (e.g., one or more of a Wi-Fi transceiver; Bluetooth transceiver; near-field communication (NFC) device; wireless modem or cellular radio utilizing GSM, CDMA, 3G and/or 4G technologies; etc.) and/or a wired network connector port 118 (e.g., one or more of an Ethernet port, cable modem, FireWire cable, Lightning connector, universal serial bus (USB) port, etc.). The communication components 272 are suitable for communication between the evaluator hub device 130 and other local and/or remote computing devices, e.g., the evaluator input device 110 and/or the target device 120, directly via a wired or wireless peer-to-peer connection and/or indirectly via the communication link 270. For example, the wireless transceiver 274 of the evaluator hub device 130 can connect to the wireless transceiver 282 of the target device 120 and/or the wireless transceiver 252 of the evaluator input device 110 via the wireless connection, and/or the wired connector port 118 of the evaluator hub device 130 can connect to the wired connector port 122 of the target device 120 via the wired connection 140. The evaluator hub device 110 further includes power 266, which can include battery power and/or facility power for operation of the various electrical components associated with the evaluator hub device 130.

The target device 120 can include, among other components, one or more communication components 280. The communication components 280 can include, for example, a wireless transceiver 282 (e.g., one or more of a Wi-Fi transceiver; Bluetooth transceiver; near-field communication (NFC) device; wireless modem or cellular radio utilizing GSM, CDMA, 3G and/or 4G technologies; etc.) and/or a wired network connector port 122 (e.g., one or more of an Ethernet port, cable modem, FireWire cable, Lightning connector, universal serial bus (USB) port, etc.). The communication components 280 are suitable for communication between the target device 120 and other local and/or remote computing devices (e.g., evaluator input device 110, the evaluator hub device 130) directly via a wired or wireless peer-to-peer connection and/or indirectly via the communication link 270 (which can include the Internet, a public or private intranet, a local or extended Wi-Fi network, cell towers, the plain old telephone system (POTS), etc.). For example, the wireless transceiver 282 of the target device 120 can connect to the wireless transceiver 282 of the target device 120 and/or the wireless transceiver 252 of the evaluator input device 110 via the communication link 270, and/or the wired connector port 122 of the target device 120 can connect to the wired connector port 118 of the evaluator hub device 130 via the wired connection 140.

Unless described otherwise, the construction and operation of the various components shown in FIG. 2 are of conventional design. As a result, such components need not be described in further detail herein, as they will be readily understood by those skilled in the relevant art. In other embodiments, the evaluator input device 110 and/or the target device 120 can include other features that may be different from those described above. In still further embodiments, the evaluator input device 110 and/or the target device 120 can include more or fewer features similar to those described above.

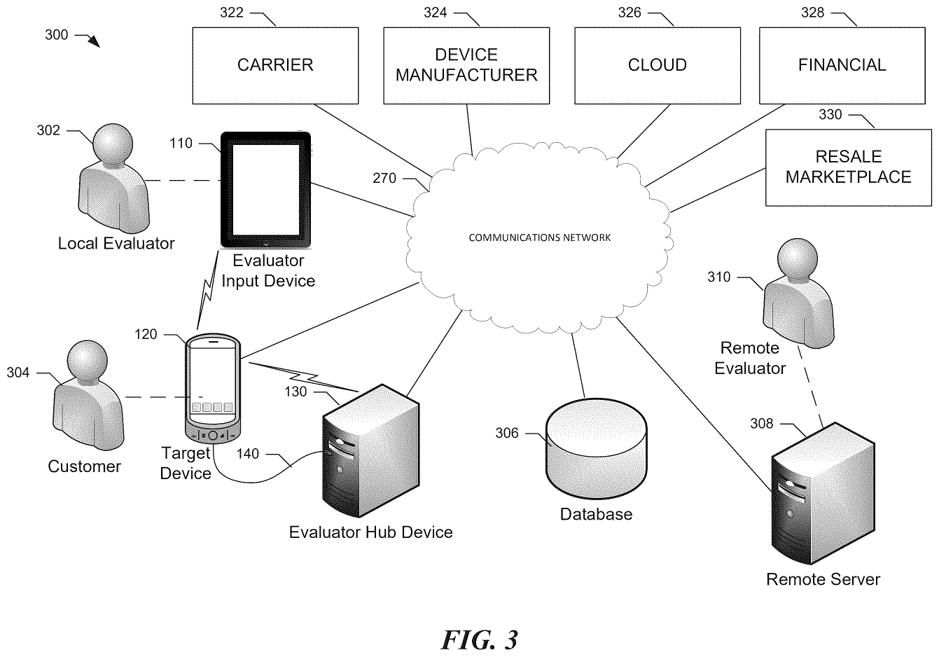

FIG. 3 is a schematic diagram of a suitable network environment 300 for implementing various aspects of a target device evaluating and recycling system configured in accordance with embodiments of the present technology. In the illustrated embodiment, various computing devices including the evaluator input device 110 and the evaluator hub device 130 can exchange information with one or more remote computers (e.g., one or more server computers 308) via the communication link 270. Although the communication link 270 can include a publicly available network (e.g., the Internet with a web interface), a private communication link, such as an intranet or other network can also be used. Moreover, in various embodiments the individual evaluator input device 110 and/or the evaluator hub device 130 can be connected to a host computer (not shown) that facilitates the exchange of information between the evaluator input device 110, the evaluator hub device 130, remote computers, mobile devices, etc.

The remote server 308 can perform many or all of the functions for receiving, routing and storing of electronic messages, such as data lookup queries, webpages, audio signals and electronic images and/or video necessary to implement the various electronic transactions described herein. For example, the remote server 308 can retrieve and exchange web pages and other content with an associated database or databases, for example in some embodiments the remote server 308 can communicate with the database 306, which can store information relating to customers of a particular retail store or group of retail stores, including past purchases, model of purchased devices, insurance plans, carrier service plans, etc. In some embodiments, the database can include information related to target devices 120 such as mobile phones and/or other consumer electronic devices. Such information can include, for example, make, model, serial number, International Mobile Equipment Identity (IMEI) number, carrier plan information, pricing information, owner information, etc. In various embodiments the remote servers 308 can also include a server engine, a web page management component, a content management component, and/or a database management component. The server engine can perform the basic processing and operating system level tasks associated with the various technologies described herein. The webpage management component can handle creation and/or display and/or routing of web or other display pages. The content management component can handle many of the functions associated with the routines described herein. The database management component can perform various storage, retrieval and query tasks associated with the database, and can store various information and data such as animation, graphics, visual and audio signals, etc.

In the illustrated embodiment, the evaluator input device 110 and the evaluator hub device 130 can also be operably connected to each other and/or to a plurality of other remote devices and systems via the communication link 270. For example, the evaluator input device 110 can include wired and/or wireless communication facilities for exchanging digital information with the target devices 120 for recycling. The evaluator input device 110, the evaluator hub device 130, and/or the remote server 308 can also be operably connectable to a series of remote computers for obtaining data and/or exchanging information with necessary service providers, financial institutions, device manufactures, authorities, government agencies, etc. For example, the evaluator input device 110, the evaluator hub device 130, and/or the remote server 308 can be operably connected to one or more cell carriers 322, one or more device manufacturers 324 (e.g., mobile phone manufacturers), one or more electronic payment or financial institutions 328, one or more databases (e.g., the Group Speciale Mobile Association (GSMA) International Mobile Equipment Identity (IMEI) Database, etc.), and one or more computers and/or other remotely located or shared resources associated with cloud computing 326. The financial institutions 328 can include all manner of entity associated with conducting financial transactions, including banks, credit/debit card facilities, online commerce facilities, online payment systems, virtual cash systems, money transfer systems, etc.

In addition to the foregoing, the evaluator input device 110, the evaluator hub device 130, and/or the remote server 308 can also be operably connected to a resale marketplace 330. The resale marketplace 330 represents a system of remote computers and/or services providers associated with the reselling of consumer electronic devices through both electronic and brick and mortar channels. Such entities and facilities can be associated with, for example, online auctions for reselling used electronic devices as well as for establishing market prices for such devices.

Individuals interacting in the networked environment 300 include a local evaluator 302 who utilizes the evaluator input device 110. The local evaluator 302 can be, for example, an employee associated with a retail store (e.g., a carrier store, an electronics store, a department store, ect.) or other such establishment. A customer 304 is the owner of the target device 120 which is a candidate for recycling. As described in more detail below, the customer 304 can take the target device 120 to the store for evaluation and possible recycling, for example with the assistance of the local evaluator 302 using the evaluator input device 110. Additionally, in some embodiments a remote evaluator 310 can interact with the remote server 308, for example, to verify images and/or video of the target device 120 or to otherwise assist the local evaluator 302 in evaluating the target device 120 of the customer 304.

The foregoing description of the networked environment 300 illustrates but one possible network system suitable for implementing the various technologies described herein. Accordingly, those of ordinary skill in the art with appreciate that other systems consistent with the present technology can omit one or more of the facilities described in reference to FIG. 3, or can include one or more additional facilities not described in detail in FIG. 3.

The evaluator input device 110, target devices 120, remote server 308, user computers or devices, etc. can include one or more central processing units or other logic-processing circuitry, memory, input devices (e.g., keyboards and pointing devices), output devices (e.g., display devices and printers), and storage devices (e.g., magnetic, solid state, fixed and floppy disk drives, optical disk drives, etc.). Such computers can include other program modules such as an operating system, one or more application programs (e.g., word processing or spreadsheet applications), and the like. The computers can include wireless computers, such as mobile phones, personal digital assistants (PDAs), palm-top computers, tablet computers, notebook and laptop computers desktop computers, e-readers, music players, GPS devices, wearable computers such as smartwatches and Google® Glass™, etc., that communicate with the Internet via a wireless link. The computers may be general-purpose devices that can be programmed to run various types of applications, or they may be single-purpose devices optimized or limited to a particular function or class of functions. Aspects of the invention may be practiced in a variety of other computing environments.

While the Internet is shown, a private network, such as an intranet can likewise be used herein. The network can have a client-server architecture, in which a computer is dedicated to serving other client computers, or it can have other architectures such as peer-to-peer, in which one or more computers serve simultaneously as servers and clients. A database or databases, coupled to the server computer(s), stores much of the web pages and content exchanged between the user computers. The server computer(s), including the database(s), can employ security measures to inhibit malicious attacks on the system, and to preserve integrity of the messages and data stored therein (e.g., firewall systems, message encryption and/or authentication (e.g., using transport layer security (TLS) or secure sockets layer (SSL)), password protection schemes, encryption of stored data (e.g., using trusted computing hardware), and the like).

One skilled in the relevant art will appreciate that the concepts of the invention can be used in various environments other than location based or the Internet. In general, a display description can be in HTML, XML, or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, can be used instead of the Internet. The system can be conducted within a single computer environment, rather than a client/server environment. Also, the user computers can comprise any combination of hardware or software that interacts with the server computer, such as television-based systems and various other consumer products through which commercial or noncommercial transactions can be conducted. The various aspects of the invention described herein can be implemented in or for any e-mail environment.

Although not required, aspects of the invention are described in the general context of computer-executable instructions, such as routines executed by a data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a LAN, a WAN, or the Internet. In a distributed computing environment, program modules can be located in both local and remote memory storage devices.

Those of ordinary skill in the art will appreciate that the routines and other functions and methods described herein can be implemented as an application specific integrated circuit (ASIC), by a digital signal processing (DSP) integrated circuit, through conventional programmed logic arrays and/or circuit elements. While many of the embodiments are shown and described as being implemented in hardware (e.g., one or more integrated circuits designed specifically for a task), such embodiments could equally be implemented in software and be performed by one or more processors. Such software can be stored on any suitable computer-readable medium, such as microcode stored in a semiconductor chip, on a computer-readable disk, or downloaded from a server and stored locally at a client.

Aspects of the invention can be stored or distributed on tangible computer-readable media, including magnetically or optically readable computer discs, hard-wired or preprogrammed chips (e.g., EEPROM semiconductor chips), nanotechnology memory, biological memory, or other data storage media. The data storage devices can include any type of computer-readable media that can store data accessible by a computer, such as magnetic hard and floppy disk drives, optical disk drives, magnetic cassettes, tape drives, flash memory cards, DVDs, Bernoulli cartridges, RAM, ROMs, smart cards, etc. Indeed, any medium for storing or transmitting computer-readable instructions and data may be employed, including a connection port to a network such as a LAN, WAN, or the Internet. Alternatively, computer implemented instructions, data structures, screen displays, and other data under aspects of the invention can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). The terms “memory” and “computer-readable storage medium” include any combination of temporary, persistent, and/or permanent storage, e.g., ROM, writable memory such as RAM, writable non-volatile memory such as flash memory, hard drives, solid state drives, removable media, and so forth, but do not include a transitory propagating signal per se.

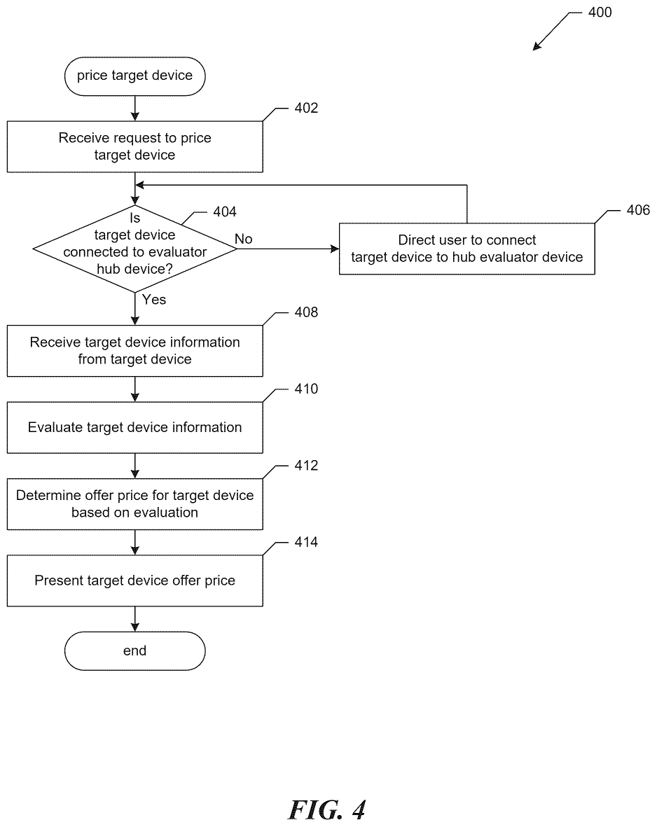

FIG. 4 is a high-level flow diagram of a routine 400 for pricing a target device (e.g., the target device) 120 of FIG. 1, such as a mobile phone, tablet computer, mp3 player, TV, SLR, etc.) for recycling in accordance with embodiments of the present technology. In various embodiments, an application running on an evaluator device (e.g., the evaluator input device 110 of FIG. 1 such as a tablet), and/or another processing device operatively connectable to the evaluator device, such as a remote computer (e.g., the evaluator hub device 130 of FIG. 1), can perform some or all of the routine 400. In some instances, for example, a user who owns the target device 120 (e.g., a mobile phone, etc.) may want to know how much the target device 120 is worth so that he or she can decide whether to sell it. The routine 400 of FIG. 4 enables a clerk at a retail store or other such individual to utilize the evaluator input device 110 to quickly obtain a current price for the target device 120.

In various embodiments, the routine 400 and the other flow routines described in detail herein can be implemented by one or more applications (“apps”) running on the evaluator input device 110, the evaluator hub device 130, and/or one or more remote servers 308. For example, the evaluator input device 110 can run an app that can obtain information about a connected target device 120. The target device 120 may be, for example, one of various consumer electronic devices, such as a used mobile telecommunication device, which includes all manner of handheld devices having wired and/or wireless communication capabilities (e.g., a smartphone, computer, TV, game console, home automation device, etc.). In some embodiments, the local evaluator 302 (FIG. 3) downloads the app to the evaluator input device 110 from an app store or other software repository associated with the device manufacturer 324 or a third party (e.g., the Apple® App StoreSM, Google Play™ store, Amazon® Appstore™, a third party device recycler or reseller, etc.), from a website, from a removable memory device such as an SD flash card or USB drive, etc. In other embodiments, the app is loaded on the evaluator input device 110 before it is first acquired by the local evaluator 302 (e.g., preinstalled by the device manufacturer 324, a wireless service carrier 322, a device recycler, a device vendor, etc.).

In block 402, the routine 400 begins by receiving a request to price a target device 120. The request can be, for example, provided by the local evaluator 302, and the target device 120 can be provided by the customer 304 interested in selling the target device 120. For example, the local evaluator 302 can activate the app on the evaluator input device 110 (e.g., by selecting an icon representing the app on a touch screen of the evaluator input device 110) and choose a function to begin a process to price the target device 120. In some embodiments, the app enables the local evaluator 302 to select a particular make and/or model corresponding to the target device 120 from a list of electronic devices corresponding to devices connected to the evaluator input device 110, and/or from a list of electronic devices previously saved in the memory 240 for evaluation and pricing.

In some instances, the target device 120 is electrically connected to the evaluator input device 110 (e.g., via a data cable or the wireless data connection 132), while in other instances, the target device 120 may be disconnected from the evaluator input device 110 when the local evaluator 302 wants to find out how much the target device 120 is worth. In decision block 404, the routine 400 determines whether the target device 120 is communicatively connected to the evaluator hub device 130. For example, the evaluator input device 110 and the evaluator hub device 130 can be connected over a wired or wireless network connection, allowing the two devices to communicate with one another during the evaluation process. The evaluator hub device 130 can include the electrical connector 140 configured to connect to the target device 120 at one end (using, for example, a Lightning connector) and at the evaluator hub device 130 at the other end (via, for example, a USB connector). In some embodiments, the evaluator input device 110 and the evaluator hub device 130 can be the same machine, for example a laptop or tablet computer. Such a laptop or computer may be used by the local evaluator 302 to provide input regarding the target device 120 and can also be electrically connected to the target device 120 (e.g., via wired connection 140) for electrical evaluation of the target device 120.

If the target device 120 is not connected to the evaluator hub device 130, then in block 406 the routine 400 directs the user to connect the target device 120 to the evaluator hub device 130 via the wired connection 140. For example, the app can display instructions on the screen 115 of the evaluator input device 110 directing the local evaluator 302 or the customer 304 to connect the device 120 to the evaluator hub device 130 by plugging the cable 140 into both devices, by pairing the devices to each other over a short-range communication link such as Bluetooth or NFC, or by joining both devices to a common network such as an Ethernet or Wi-Fi LAN. In some embodiments, the routine 400 can associate the target device 120 with one or more connection types, so that the instructions to connect the target device 120 to the evaluator input device 110 are specific to an associated connection type. In some embodiments, the app is configured to automatically detect when the target device 120 is connected to the evaluator hub device 130. The routine 400 can thus automatically detect newly connected target devices 120 and provide an indication of the new devices to the user. In some embodiments, the app receives user input (e.g., by selection of an option on the touchscreen 212) indicating that the target device 120 is available via a wired connection 140 or a wireless connection, and the app can respond by attempting to connect to the indicated target device 120. After block 406, the routine 400 returns to decision block 404.

Once the target device 120 is connected to the evaluator hub device 130, the routine 400 proceeds to block 408. In block 408, the routine 400 receives or otherwise obtains information about the target device 120 from the target device 120 via the app. In some embodiments, the routine 400 obtains the information automatically, i.e., without receiving manual user input associated with the information. For example, a USB host (e.g., the evaluator hub device 130) can prompt a USB peripheral (e.g., the target device 120) to transmit its vendor ID number (a code identifying the manufacturer of the USB peripheral) and its device ID number (a code identifying the model of the USB peripheral). In some embodiments, the evaluator hub device 130 is connected to the target device 120 via the USB cable into and the evaluator hub device 130 receives vendor ID and device ID codes from the target device 120 over the USB cable connection. In other embodiments, the evaluator hub device 130 is connected to the target device by one or more of various other types of wired or wireless data connections, and can obtain different information. The information obtained from the evaluator hub device 130 can then be transmitted to the evaluator input device 110, for example for display via the screen 115 of the evaluator input device 110. The routine 400 can store the information about the target device 120 in a data structure on the evaluator input device 110 (e.g., in a table maintained by the app), on the evaluator hub device 130, and/or remotely from the evaluator input device 110 or the evaluator hub device 130 (e.g., in a data structure maintained at one or more of the server computer 308, the cloud storage facility 326, etc.).

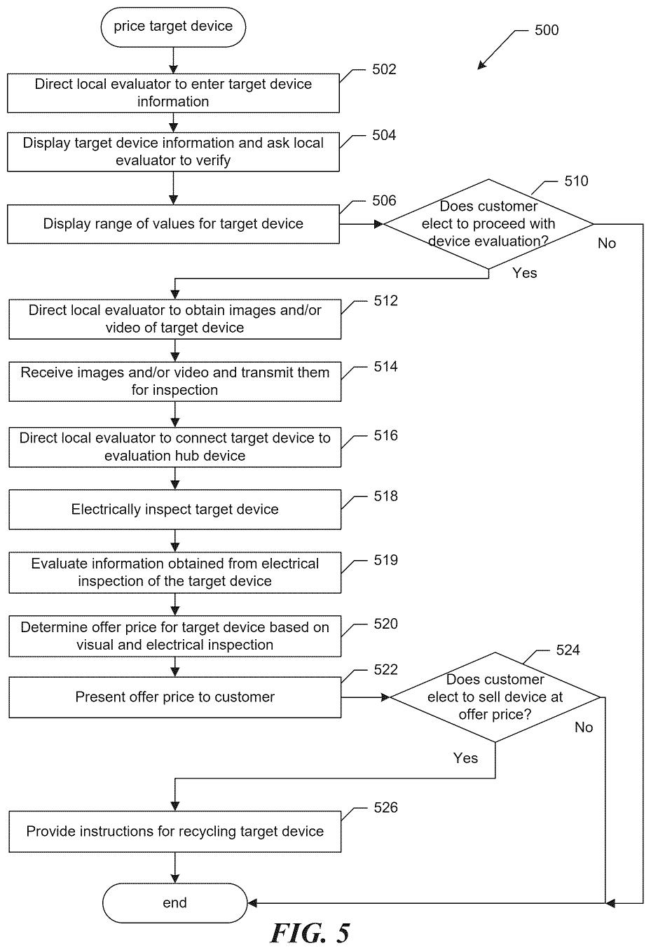

In block 410, the routine 400 evaluates the target device information. In some embodiments, the routine 400 performs the evaluation automatically, i.e., without receiving user input manually evaluating the target device 120. As part of evaluating the target device 120, the evaluator hub device 130 can identify the target device 120 and/or assess its condition, as described in more detail below with respect to FIG. 5. For example, the evaluator hub device 130 can identify the target device 120 by determining one or more of the target device platform, make, model, carrier (for a mobile phone, for example), features, configuration (e.g., memory and/or other storage capacity), upgrades, peripherals, etc. based on the target device information. For example, if the information includes a device part number MD761LL/B, the evaluation can determine that the target device 120 is an Apple® MacBook Air® laptop computer with a 13.3″ screen and 256 GB of flash storage from early 2014. In various embodiments, the app or a remote server can query a local or remote database (e.g., the database 306 in FIG. 3) using the target device information. For example, after the app receives USB vendor ID and device ID codes, the routine 400 can search a local and/or remote data structure that maps those codes to information about the USB device. As another example, the app or the remote server can obtain information including a mobile phone IMEI number and can then communicate remotely (via, e.g., a wireless or wired link) with a backend database such as the GSMA IMEI Database, parsing the IMEI to determine or verify the make and/or model of the mobile phone.

In block 412, the routine 400 determines an offer price for the target device 120 based on the evaluation performed in block 410. For example, the routine 400 can consult a local or remote database (for example, the database 306) to price the target device 120 based on the information and the evaluation of the target device 120. For example, when the evaluation has determined the make, model, and configuration of the target device 120, the routine 400 can search a data structure that maps the make, model, and/or configuration of the device to a price for the device. For example, if the evaluation has determined that the target device 120 is an Apple® MacBook Air® laptop computer with a 13.3″ screen and 256 GB of flash storage from early 2014, the routine 400 can query a pricing data structure or service to obtain a current price for the target device 120 based on that determination. In some embodiments, the app can transmit some or all of the information received in block 408 and/or the results of the evaluation performed in block 410 to a remote server. The remote server can then use the information and/or evaluation results to determine the current market value of the target device 120 (such as by looking up the value of the target device 120 in a database) and return a price that the app can offer the user for the target device 120. In other embodiments, the app on the evaluator input device 110 downloads pricing data from a remote server (e.g., the server computer 308 of FIG. 3), and the app determines an offer price for the target device 120 based on the pricing data downloaded from the server. For example, in some embodiments, the app can download a database of prices, such as a lookup table, pricing model, or other data structure containing prices for popular electronic devices. The app can use the information about the make and model of the target device 120 to look up the current value of the subject target device 120 in the table. In various embodiments, the pricing data is updated periodically, such as daily. The routine 400 can ensure that such pricing data is kept current, so that the app offers only current, accurate prices.

In block 414, the routine 400 presents the price for the target device 120 to the user. For example, the app can display the offer price on the display screen 115 of the evaluator input device 110, and/or a remote server can send the device owner (e.g., the customer 304), a text message or email containing the price that the user can obtain by selling the target device 120 within a certain time. For example, the routine 400 can indicate that the offer price will be valid for a certain period of time. In some embodiments, the app can reward the user with incentives for submitting the target device 120 for recycling. Such incentives can include, for example, a time-expiring offer, a coupon valid at the store in which the evaluator input device 110 and evaluator hub device 130 are located, a bonus for recycling additional devices, a referral bonus, etc. In some embodiments, the routine 400 can provide a higher offer price to the customer 304 if the customer uses the dispensed value toward the purchase of a new device or other product at the retail store. After block 414, the routine 400 ends.

FIG. 4 and the flow diagrams that follow are representative and may not show all functions or exchanges of data, but instead they provide an understanding of commands and data exchanged under the system. Those skilled in the relevant art will recognize that some functions or exchange of commands and data may be repeated, varied, omitted, or supplemented, and other (less important) aspects not shown may be readily implemented. Those skilled in the art will appreciate that the blocks shown in FIG. 4 and in each of the flow diagrams discussed below may be altered in a variety of ways. For example, while processes or blocks are presented in a given order, alternative implementations may perform routines in a different order, and some processes or blocks may be rearranged, deleted, moved, added, subdivided, combined, and/or modified to provide alternative or sub-combinations. Each of these processes or blocks may be implemented in a variety of different ways. Also, although processes or blocks are at times shown as being performed in series, these processes or blocks may instead be performed or implemented in parallel, or may be performed at different times. Some of the blocks depicted in FIG. 4 and the other flow diagrams are of a type well known in the art, and can themselves include a sequence of operations that need not be described herein. Those of ordinary skill in the art can create source code and/or microcode, program logic arrays, or otherwise implement the invention based on the flow diagrams and the detailed description provided herein.

In various embodiments, all or a portion of the routine 400 and the routines in the other flow diagrams herein can be implemented by means of a consumer or other user (such as a retail employee) operating one or more of the electronic devices and systems described above. For example, in some embodiments, the routine 400 and other routines disclosed herein can be implemented by a mobile device, such as the evaluator input device 110 described above with reference to FIG. 1 or stationary devices such as the evaluator hub device 130. In some instances, the routines can be implemented by one or more apps that can run on one or more evaluator input devices 110, evaluator hub devices 130, and/or on one or more target devices 120. In some embodiments, portions (e.g., blocks) of the routine can be performed by one or more remote computers. For example, such remote computers can include one or more of the remote server 308 of FIG. 3 and/or computing resources associated with the cloud 326 or the resale marketplace 330, separately or in combination. The remote computers can perform the routines described herein using one or more local and/or remote databases (e.g., the database 306 of FIG. 3, or such as the GSMA IMEI Database). Accordingly, the description of the routine 400 and the other routines disclosed herein may refer interchangeably to the routine, the app, the evaluator input device 110, the evaluator hub device 130, and/or the target device 120 performing an operation, with the understanding that any of the above devices, systems, and resources can perform all or part of the operation.

While various embodiments of the present technology are described herein using mobile phones and other handheld devices as examples of electronic devices, the present technology applies generally to all types of electronic devices. For example, in some embodiments, the app can be installed and/or run on a larger evaluator input device 110, the evaluation hub device 130, and/or the target device 120, e.g., a laptop or tower computer, to perform all or a portion of the routine 400.

FIG. 5 is a flow diagram of a routine 500 for pricing a target device 120 (e.g., a mobile phone, laptop computer, VolP phone, smartwatch, etc.) for recycling in accordance with embodiments of the present technology. The routine 500 of FIG. 5 depicts a process similar to the routine 400 of FIG. 4, but may have additional and/or alternative steps. In various embodiments, one or more apps can run on an evaluator device (e.g., the evaluator input device 110 of FIG. 1) and/or another processing device operatively connectable to the app, such as a evaluator hub device 130 or a remote server, can perform some or all of the routine 500. In some instances, a customer 304 (FIG. 3) who owns a target device 120 may bring the target device 120 to a retail store to determine how much the target device 120 is worth so that he or she can make an informed decision about whether to sell it. The routine 500 of FIG. 5 enables the local evaluator 302, such as a clerk or other individual at the retail store (or other location housing the evaluator input device 110), to use the evaluator input device 110 to conveniently price the target device 120 of the customer 304.

In block 502, the routine directs the local evaluator 302 (e.g., a retail clerk) to enter target device information. For example, the local evaluator 302 can inspect the target device 120 that the customer 304 has brought into the store and enter relevant information (e.g., via the touchscreen 212 or other interface of the evaluator input device 110; FIG. 2) such as the make, model, IMEI number, etc. In some embodiments, a customer may wish to recycle a peripheral or other electronic device (e.g., such as USB devices, speakers, printers, hard disk drives, mobile phones, computers, etc.) and in some embodiments, the devices are plugged into the evaluator input device 110. The app running on the evaluator input device 110 can query an operating system 242 Application Programming Interface (API) of the evaluator input device 110 to obtain information about peripherals or other electronic devices operably connected to the evaluator input device 110, For example, in an evaluator input device 110 running an Android™ operating system 242, the app can discover USB devices by either using an intent filter to be notified of each system event when a USB device is attached, or by enumerating USB devices that are already connected using a UsbManager class getDeviceList( ) method. As another example, the app can monitor traffic on networks to which the evaluator input device 110 is connected (e.g., Ethernet and/or Wi-Fi), and detect other devices that send communications over those networks.

Information entered by the local evaluator 302 into the evaluator input device 110 can be transmitted to remote servers (e.g., remote server 308) and databases (e.g., database 306) for storage and analysis. This information could go directly to the server or be proxied through a computer or server (e.g., the evaluator hub device 130) that is on the same network that the evaluator input device 110 is connected to via WiFi.

In block 504, the routine displays the target device 120 information and asks the local evaluator 302 to verify it. In cases in which the local evaluator 302 has manually entered the information, this serves as a confirmation step to review entered information. In cases in which the information has been automatically obtained, for example via a WiFi connection to the target device, the local evaluator can compare the displayed target device 120 information to the actual target device 120 that the customer has brought into the store to confirm that the information corresponds to the actual device. If the information is correct, the local evaluator can confirm, for example via the touchscreen 212 interface of the evaluator input device 110.

In block 506, the routine displays a range of values for the target device 120, for example via the display 115 of the evaluator input device 110. For example, based on the specified target device 120, a range of possible resale values can be provided such as “$150-$325” depending on the condition of the target device 120. This range can represent an estimated value range for an as-yet unverified target device, which allows the customer 304 to determine whether to proceed with the full evaluation of the target device 120. Along with the range of values for the target device 120, the routine can present additional information to the customer 304 such as upgrade plans, options, and promotions that the retail store, carrier, or other entity has in place.

In decision block 510, the routine determines if the customer 304 elects to proceed with the device evaluation. If the customer 304 declines, then the routine ends. The customer's decision can be input via, for example, the touchscreen 212 associated with the evaluator input device 110, either by the local evaluator 302 or by the customer 304 herself. If the customer 304 elects to proceed, then the routine continues to block 512.

In block 512, the routine 500 directs the local evaluator 302 to obtain images and/or video of the target device 120. In some embodiments, the local evaluator 302 is directed to take specific pictures of the device using the camera 216 associated with the evaluator input device 110. For example the local evaluator 302 can be directed to take pictures of the front, back, and sides of the target device 120. In some embodiments, the local evaluator 302 can be directed to take images and/or video of the target device 120 with the screen both on and off.

In block 514, the routine 500 receives the images and/or video of the target device 120 and transmits them for inspection. For example, the images and/or video may be transmitted via communication link 270 (FIG. 2) to the remote server 308 (FIG. 3) for evaluation by one or more remote evaluators 310. The remote evaluator 310 can, in some embodiments, be a human staff member who is trained to review these images and/or video and grade the mechanical, LCD and other aspects of the target device 120. For example, in one embodiment the remote evaluator 310 can be an individual viewing images and/or video of the target device 120 on a display screen. The individual can rank the condition of the target device 120 based on her review of the images and/or video, for example ranking the target device 120 on a scale of 1 to 5, where 1 is poor condition and 5 is excellent condition. In some embodiments, the remote evaluation can be performed partly or wholly using machine vision techniques or other forms of automated visual inspection, without the need for trained human staff to view the images and/or video. For example, automatic machine vision can use algorithms to detect the presence of cracks on the screen, identify dead pixels, etc. In one example, a Canny edge detector can be applied to an image of the screen to identify cracks. In another example, the image of the target device can be compared with a sample image of the same make and model of electronic device that has no defects. The image of the target device can be subtracted from the sample image and the resulting image analyzed for the presence of cracks, dead pixels, or other defects.

In block 516, the routine directs the local evaluator 302 to connect the target device 120 to the evaluator hub device 130. The target device 120 can be connected to the evaluator hub device 130 via the wired connection 140, which as noted above can include a USB connector or other type of electrical connector for connection to the target device 120.

Once the target device 120 is connected to the evaluator hub device 130, the routine 500 electronically inspects the target device 120 in block 518. For example, the evaluator hub device 130 can query the target device 120 for information such as a device identifier (e.g., an IMEI number, serial number, etc.). In various embodiments, the format of the request and the type of information that can be received in response depends on the evaluator hub device 130 platform and on the type of connection between the evaluator hub device 130 and the target device 120. For example, when a target USB device is connected to a USB host, evaluation device, the host (e.g., the host USB controller) typically queries the target device with a GET_DESCRIPTOR query, which is specific to USB connections. Devices connected by other connection types (e.g., FireWire, Bluetooth, Thunderbolt, HDMI, Wi-Fi, etc.) can query target devices according to their the target device's protocols. In some embodiments, the routine 500 requests information from the target device 120 indirectly. For example, in some instances the target device 120 is a device that is configured to always act as a USB host device (e.g., the “A-device” connected to the “A” end of a USB cable). In these instances, when the evaluator hub device 130 is connected to the target device 120 via a USB connection, the target device 120 controls the USB. In such instances, the evaluator hub device 130 can, for example, act as a mass storage device (e.g., a USB memory stick) that contains an auto-run file configured to be automatically executed by the host computer. When the target device 120 detects the connected evaluator hub device 130 as a mass storage device, the target device 120 accordingly executes instructions from the auto-run file. The evaluator hub device 130 can thus cause the target device 120 to copy information from the target device 120 to the evaluator hub device 130.

In some embodiments, the routine 500 can directly obtain detailed information about the target device 120 and its configuration after the customer 304 gives the app permission to obtain some or all of the information that would be useful to determine the value of the target device 120. For example, when an evaluator hub device 130 is connected to an iOS® target device 120 via a USB or Wi-Fi connection, the target device 120 may display a dialog on a touchscreen of the target device 120 asking the user whether to “Trust This Computer?”, i.e., the evaluator hub device 130, and display virtual buttons labeled “Trust” and “Don't Trust”. The customer 304 can select the “Trust” option allowing the evaluator hub device 130 to access settings and data on the target device 120 such as a the target device's IMEI number, make, model, memory capacity, etc. As another example, in some instances, the app can be installed and/or run on more than one device, enabling the apps to cooperatively evaluate the target device 120. For example, if the target device 120 and the evaluator hub device 130 are both running instances of the app, and the app running on the target device 120 can communicate with the app running on the evaluator hub device 130, then the app running on the target device 120 can directly access information about the target device 120 (e.g., using APIs or data stores) and communicate that information to the app running on the evaluator hub device 130.

In some embodiments, the evaluator hub device 130 can electronically request information from the target device using, for example, a USB GET_DESCRIPTOR query. In response to this query, the target USB device can transmit codes representing the device class and subclass (indicating the functional type of the device, such as a printer device, smart card device, still imaging device, video device, etc.), the IMEI number (indicating the make of the device, such as Apple, Inc.), and the product ID and release number (indicating the model of the device, such as a Thunderbolt Display). In some embodiments, the routine 500 receives such information about target USB devices in response to a system level API query or by reading a system data file.

In some embodiments, the app can query a USB. org vendor ID list with the target device vendor ID code to obtain the name of the target USB device vendor. As another example, the app or the remote server can obtain a target mobile phone IMEI number and then communicate remotely (via, e.g., a wireless or wired link) with a backend database such as the GSMA IMEI Database, parsing the IMEI to determine or verify the phone make and/or model. The routine 500 can use such queries to obtain meta-information to e.g., confirm whether various sources of information about the target device 120 are consistent with each other. Evaluating the target device 120 can also include determining what kind of information is and is not available about the target device 120. For example, depending on the type of electronic device, it may or may not be possible to perform tests to gauge the condition of the target device 120 (e.g., to assess the processor, the battery, and/or the screen, and so on). In some embodiments, evaluating the target device 120 includes determining whether the target device 120 is associated with a remote user account that enables remote user control of the target device 120 (such as tracking the target device 120 and/or erasing data from the target device 120), and/or identifying other potential issues that could affect the operation of the target device 120, its resale value, and/or its ability to be resold.

In some embodiments, the customer allows the evaluator hub device 130 to have access to the data on the target device 120, and the routine 500 can receive detailed information about the target device 120. For example, on a mobile phone target device 120, the app can access logs to obtain information such as the number of charge-discharge cycles (to indicate the condition of the rechargeable battery in the phone) and/or call logs (to indicate possible issues with radio hardware or software if calls recently were not successfully completed), etc. The app can obtain information necessary to identify and/or evaluate the target device, such as a unique identifier (e.g., an IMEI number or an MEID or equivalent number of a mobile phone, a hardware media access control address (MAC address) of a networkable device, or a model number and serial number of the electronic device); information describing the device manufacturer (e.g., a manufacturer name or ID code), model, characteristics and capabilities (e.g., CPU type and speed, storage capacity (SRAM, DRAM, disk, etc.), wireless carrier, radio bands (frequency ranges and encodings such as CDMA, GSM, LTE, etc.), and/or color); and the like. Characteristic information about the target device 120 includes the device make, model, and configuration. In some embodiments, the app can obtain information about the target device 120 and/or the user (e.g., location information) stored in the memory of the target device 120 and/or access features of the target device 120 such as the camera and/or radios.

In block 519, the routine 500 evaluates the information obtained from the electrical inspection of the target device in block 518. Evaluating the information about the target device 120 can include, for example, assessing the physical and/or electrical condition of the target device 120 based on the information obtained in blocks 516 and 518, so that the app can price the target device 120 based at least in part on its condition. In some embodiments, the app can perform tests to reveal the condition of the target device 120, such as tests of processor performance, battery charging rates and/or capacity, memory tests for quality of the memory, test calls to confirm sufficient operation of device radios, and so forth). In some embodiments, the local evaluator 302 can provide input regarding evaluation of the target device 120. For example, the app can perform interactive tests that incorporate user (e.g., local evaluator 302) feedback, such as screen tests (e.g., asking whether there are any cracks in the glass and/or displaying a solid color or pattern on an LCD or LED display and prompting the user to identify dead or stuck pixels in the display), and/or interactive tests that include user action such as directing the user to activate a function on the target device 120 (e.g., turning on a Bluetooth radio so that the app on the evaluator input device 110 can detect and/or test the radio function). In some embodiments, the target device 120 has a display screen, and the routine 500 can cause the target device 120 to display a test pattern or information on its display screen for the user to inspect and/or interact with. If the user is able to view the pattern or information and, e.g., respond to prompts regarding the pattern or information, the routine 500 can establish that the target device screen, touchscreen, keyboard, and/or other components of the target device 120 are working. In some embodiments, input from the local evaluator 302 can be solicited and received when the local evaluator 302 is obtaining images and/or video of the target device 120 (e.g., in blocks 512 and 514).

In block 520, the routine 500 determines an offer price for the target device 120 based on the visual and electrical inspection of the target device 120. In various embodiments, the app on the evaluator input device 110, the evaluator hub device 130, and/or a remote server 308 can query a local or remote database (e.g., the database 306) using the evaluation in block 519. Based on the electrical and visual inspections, the routine 500 determines an appropriate offer price for the target device 120, in block 520. In some embodiments, the price can be obtained from a database or pricing model which can be, for example, a local lookup table of common devices on the evaluator input device 110, the evaluator hub device 130, and/or a remotely hosted database or web service to which the app can transmit information about the target device 120 and receive a current market value or offer price for the target device 120. In one embodiment, a database can include a range of prices for a particular make and model of target device depending on the condition. For example, the target device can be graded on a scale of 1 to 5 depending on the electrical and/or visual inspection of the device, with 1 being “poor” and 5 being “excellent.” The database can then include a price for the identified target device corresponding to each condition (e.g., condition “1”=$0; condition “2”=$100; condition “3”=$150; condition “4”=$200; and condition “5”=$250). In some embodiments, determining an offer price includes estimating a future value of the target device 120, or future values projected over time. Such projections can be based on, for example, past depreciation and/or anticipated release schedules for future devices (such as new Apple® iPhone® mobile phones).

In block 522, the routine 500 presents the customer with an offer price for the target device 120 (e.g., by displaying a message on the evaluator input device 110 via the screen 115 which local evaluator can communicate to the customer, by sending the user a text or email message, etc.). In some embodiments, the routine 500 can additionally present related offers of promotions available for recycling the target device 120.

In decision block 524, the routine 500 determines whether the customer 304 elects to recycle the target device 120 at the offer price. For example, the app can present options that the customer 304 can select to indicate the user's interest in selling the target device 120 or obtaining additional information about the recycling process, such as touchscreen 212 buttons on the display 115 of the evaluator input device 110. If the customer 304 chooses not to recycle the target device 120 or get additional information about recycling the target device 120, the routine 500 ends. Conversely, if the customer 304 elects to recycle the target device 120, then in block 526, the routine 500 provides instructions to the customer 304 for recycling the target device 120, for example the customer 304 can be instructed to power down the target device 120 and submit it to the local evaluator 302 in exchange for compensation. As another example, the routine 500 can electronically send the customer an electronic voucher or redemption code for the target device 120, which can be used in the carrier store to dispense value or award store credit to the customer in exchange for the target device 120. When recycling the target device 120, the local evaluator 302 can accept the device after confirming the identification of the customer 304 (e.g., by checking the customer's driver license, reviewing customer data in the retail store's system (e.g., via database 306), etc.). In exchange for the target device 102, the local evaluator 302 or another individual associated with the retail store can dispense value (e.g., cash, credit, etc.) to the customer 304. After block 524, the routine 500 ends.

In some embodiments, some of the information that is gathered electronically can also be gathered from the retailer or carrier database (e.g., database 306) and/or entered manually by the local evaluator 302. For instance, if the customer 304 is a returning customer, the carrier would likely have specific information on file about the target device 120. The local evaluator 302 would, in this case, know or be able to quickly obtain the IMEI number and other such information that uniquely identifies the target device 120, memory configuration, specific model version/build and other information that could affect the overall value of the device. This and other such information can be linked through interfaces and pulled to the evaluator input device 110 when the local evaluator selects a software button or other interface feature to confirm the target device 120 is the same device as is on file for that particular customer.

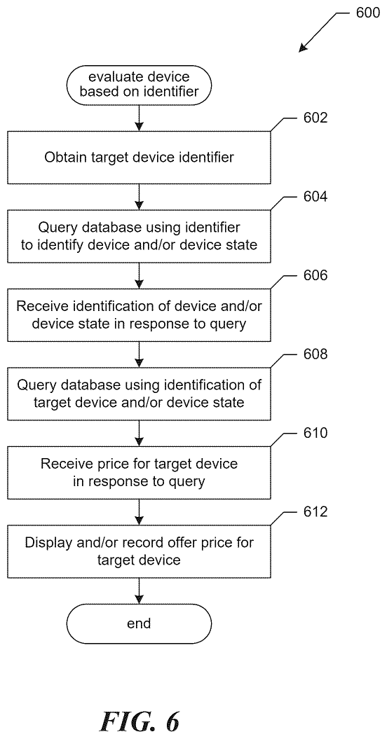

FIG. 6 is a flow diagram of a routine 600 for evaluating a target device 120 for recycling in accordance with embodiments of the present technology. In various embodiments, an app running on an evaluator device (e.g., the evaluator input device 110 of FIG. 1) and/or another processing device operatively connectable to the app, such as the evaluator hub device 130 or a remote server 308, can perform some or all of the routine 600. In some embodiments, the routine 600 can be performed when the user (e.g., the local evaluator 302) directs the app to price the target device 120 for possible recycling, causing the app to obtain information about the target device 120 (e.g., an identifier of the target device 120). The routine 600 enables the app and/or a remote processing device to identify the target device 120 and determine an offer price for the target device 120 based on the identification of the target device 120.

In block 602, the routine 600 obtains an identifier of the target device 120. Examples of target device 120 identifiers include the IMEI of a mobile phone, the model and/or serial numbers of a laptop computer, a unique wireless identifier of the target device 120 such as a Wi-Fi interface media access control address (MAC address), a product bar code, USB vendor ID and device ID (and release number) codes, etc. The app running on the evaluator input device 110 can obtain the identifier from the target device 120 using one or more of the routines described above with reference to, e.g., FIGS. 4 and 5 (electrically interrogating the target device).

In block 604, the routine 600 queries one or more databases (e.g., the database 306 of FIG. 3) using the identifier to identify the target device 120 and/or the state of the target device 120. For example, the app can construct a database query string based on information such as the model number, serial number, and/or IMEI of the target device 120 obtained by the electrical interrogation and/or visual analysis of the target device 120. The app can use one or more local and/or remote databases, such as a locally stored lookup table included in or associated with the app on the evaluator input device 110 and/or a remotely hosted database or service for responding to queries. The local and/or remote database can be a data structure indexed against device identifiers and/or configured to identify popular devices and/or target devices 120 that the customer has previously used or indicated owning. In some embodiments, for example, the app contains a database of several popular electronic devices. The app can compare the information about the target device 120 to the information in the local database to determine whether the target device 120 is one of the several popular devices. If no match is found, the app can transmit a query to a remote server for comparison against a database of a larger number of devices or ask for manual input of device identity.

In block 606, the routine 600 receives information identifying the target device 120 and/or the state of the target device 120 in response to the querying described above. For example, the app can receive an identification of the device maker, model designation, known features and/or characteristics, options and/or additional target device-specific information to prompt the user for, etc. in response to a query that includes the target device model number. The information can be received in a format or data structure that the app is configured to recognize and/or parse. The app can also communicate with remote servers and/or services such as the GSMA IMEI Database (e.g., for parsing mobile phone IMEI numbers), a database of stolen devices (e.g., including device identifiers associated with police reports), and/or a service configured to provide data about whether an electronic device is associated with a remote user account (e.g., Apple® GSX servers or the icloud.com/activationlock/“Check Activation Lock Status” web-based service for iCloud® accounts). Using the responses from such local and/or remote databases, the routine 600 can determine the identity of the target device 120 (e.g., its make and model) and determine whether the target device 120 is in an acceptable state for processing (e.g., determining whether the target device 120 is subject to remote user control such as remote tracking, locking, data erasure (“wiping”), and/or disabling (a “kill switch”), which would need to be disabled before recycling the target device).

In block 608, the routine 600 queries a database for device pricing using the identification of the target device 120 and/or the state of the target device 120. In various embodiments, the app or a remote server can query a local or remote database (e.g., the database 306) using the target device information. For example, after the app receives a standardized identification of the target device 120 (e.g., a particular model name and/or number), the routine 600 can search a local and/or remote data structure that maps the standardized identification information to pricing information for the target device 120. For example, as described above with reference to FIG. 5, the app on the evaluator input device 110 can download pricing data from a remote server (e.g., the server computer 308 of FIG. 3), such as a lookup table, pricing model, or other data structure containing prices for popular electronic devices, and look up the target device make and model in that downloaded data and/or in a remote database (e.g., the database 306). In some embodiments, the app on the evaluator input device 110 can submit a query that includes information about the state and/or condition of the target device 120, to obtain a more accurate price for the target device 120.

In block 610, the routine 600 receives an offer price for the target device 120 in response to the query. In some instances, the price includes a range of offer prices. In block 612, the routine 600 displays and/or records the offer price for the target device 120. For example, the routine 600 can present the offer price to the user (e.g., the local evaluator 302 and/or the customer 304) via the display screen 115 of the evaluator input device 110, and/or send the user an electronic message conveying the offer price for the target device 120. In addition or instead, the evaluator input device 110 app and/or the remote server can store the price in a lookup table indexed against a native or assigned identifier of the target device 120. The routine 600 can record the offer price for the target device 120 locally on the evaluator input device 110 and/or remotely (e.g., together with the information about the target device). For example, the app can store a record of the price for the target device 120 and timestamp of the price, and/or can transmit the price data to the remote server 308, or to the cloud storage facility 326, so that any remote server can retrieve the target device 120 price from a server to facilitate the purchase of the target device 120 based on the determined price. After storing the price for the target device 120, the routine 600 ends.

The present technology allows devices of various types, such as mobile phones (smartphones and feature phones, for example), tablet computers, wearable computers, game devices, media players, laptop and desktop computers, etc. (e.g., the target device 120) to be evaluated by a software application on an evaluator input device 110 to facilitate purchasing by a retailer. The present technology enables the user to use the evaluator input device 110 in conjunction with the evaluator hub device 130 to obtain information about the target device 120 and/or the user, obtain a price quote for the target device 120 so that the user can sell the target device 120 with greater certainty and speed.

The above Detailed Description of examples and embodiments of the invention is not intended to be exhaustive or to limit the invention to the precise form disclosed above. Although specific examples for the invention are described above for illustrative purposes, various equivalent modifications are possible within the scope of the invention, as those skilled in the relevant art will recognize.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

Although the above description describes various embodiments of the invention and the best mode contemplated, regardless how detailed the above text, the invention can be practiced in many ways. Details of the system may vary considerably in its specific implementation, while still being encompassed by the present technology. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

1-21. (canceled)

22. A computing system for remotely evaluating a consumer electronic device, the computing system comprising:
a device evaluation station in a first location, the device evaluation station including one or more processors and one or more non-transitory, computer-readable media programmed with instructions that, when executed by the one or more processors, cause the device evaluation station to perform operations including-receiving, from a handheld evaluator input device in a second location remote from the first location, and via a processor of the device evaluation station, a request from a first human operator for assistance evaluating the consumer electronic device;
receiving, from the handheld evaluator input device, and via the processor of the device evaluation station, an image of the consumer electronic device;
displaying, via a display screen of the device evaluation station, the image and the request to a second human operator;
receiving inspection data associated with the consumer electronic device from an evaluator hub device, wherein the evaluator hub device is configured to electrically inspect the consumer electronic device, and wherein the inspection data includes data associated with an electrical inspection of the consumer electronic device performed by the evaluator hub device; and
transmitting to the handheld evaluator input device, via the processor of the device evaluation station, a compensation value for the consumer electronic device based at least in part on the inspection data and an evaluation of the image by the second human operator.

23. The computing system of claim 22 wherein the operations further include, at the device evaluation station, sending a prompt to the first human operator via the handheld evaluator input device to connect the consumer electronic device to the evaluator hub device.

24. The computing system of claim 22 wherein receiving the image of the consumer electronic device includes:
prompting the first human operator to position the consumer electronic device in a specific orientation relative to a camera of the handheld evaluator input device, and
causing the camera of the handheld evaluator input device to obtain the image when the consumer electronic device is in the specific orientation.

25. The computing system of claim 24 wherein:
the image is a first image of the consumer electronic device in a first orientation relative to the handheld evaluator input device,
receiving the first image includes prompting the first human operator via the handheld evaluator input device to position the consumer electronic device in the first orientation relative to the handheld evaluator input device, and
the operations further include-
prompting the first human operator via the handheld evaluator input device to position the consumer electronic device in a second orientation relative to the handheld evaluator input device, the second orientation different than the first orientation, and
receiving from the handheld evaluator input device a second image of the consumer electronic device in the second orientation,
wherein the compensation value is based at least partially on the inspection data and an evaluation of the first and second images by the second human operator.

26. The computing system of claim 25 wherein:
prompting the first human operator to position the consumer electronic device in the first orientation includes prompting the first human operator to position the consumer electronic device with a device display screen of the consumer electronic device facing toward the handheld evaluator input device, and
prompting the first human operator to position the consumer electronic device in the second orientation includes prompting the first human operator to position the consumer electronic device with the device display screen facing away from the handheld evaluator input device.

27. The computing system of claim 22 wherein receiving the inspection data includes, at the device evaluation station, causing the evaluator hub device to electronically send a request for information associated with the consumer electronic device to the consumer electronic device.

28. The computing system of claim 27 wherein electronically sending the request from the evaluator hub device to the consumer electronic device includes communicating via USB, Wi-Fi, or Bluetooth.

29. The computing system of claim 27 wherein electronically sending the request from the evaluator hub device to the consumer electronic device includes querying an operating system API of the consumer electronic device for information from the consumer electronic device.

30. The computing system of claim 27 wherein electronically sending the request from the evaluator hub device to the consumer electronic device includes causing the evaluator hub device to be configured as a USB mass storage device containing an auto-run file, wherein the auto-run file includes instructions prompting the consumer electronic device to provide identification information associated with the consumer electronic device to the evaluator hub device.

31. The computing system of claim 27 wherein electronically sending the request from the evaluator hub device to the consumer electronic device includes causing the evaluator hub device to send the request via USB, and wherein receiving the inspection data includes receiving device class, vendor ID, and product ID information.

32. A computing system for remotely evaluating a consumer electronic device, the computing system comprising:
a handheld evaluator input device in a first location, the handheld evaluator input device including-
a first display screen;
an imaging device; and
a first processor configured to receive, via the first display screen, a request from a first human operator for assistance evaluating the consumer electronic device and to obtain, via the imaging device, an image of the consumer electronic device;
an evaluator hub device, including-
a communication component; and
a second processor configured to electrically inspect the consumer electronic device via the communication component to obtain inspection data associated with the consumer electronic device; and
a device evaluation station in a second location remote from the first location, the device evaluation station including-
a second display screen, and
a third processor configured to receive the request and the image from the handheld evaluator input device, to display the request and the image to a second human operator via the second display screen, to receive the inspection data from the evaluator hub device, and to transmit a compensation value for the consumer electronic device to the handheld evaluator input device determined based at least partially on the inspection data and an evaluation of the image by the second human operator.

33. The computing system of claim 32 wherein the first processor is further configured to:
query the second processor to determine whether the consumer electronic device is connected to the evaluator hub device via the communication component;
obtain an indication from the second processor that the consumer electronic device is not connected to the evaluator hub device, and
cause the first display screen to display a prompt instructing the first human operator to connect the consumer electronic device to the evaluator hub device via the communication component.

34. The computing system of claim 33 wherein the communication component includes a wireless communication component, and wherein the prompt includes instructions to pair the consumer electronic device to the evaluator hub device via the wireless communication component and/or instructions to join a wireless network associated with the wireless communication component.

35. The computing system of claim 33 wherein the communication component includes a wired connector, and wherein the prompt includes instructions to connect the consumer electronic device to the wired connector.

36. The computing system of claim 32 wherein, to obtain the image, the first processor is configured to-
prompt the first human operator to position the consumer electronic device in a specific orientation relative to the imaging device, and
cause the imaging device to obtain the image when the consumer electronic device is in the specific orientation.

37. The computing system of claim 32 wherein:
the image is a first image of the consumer electronic device in a first orientation relative to the handheld evaluator input device;
the first processor is further configured to-
display, via the first display screen, a first prompt instructing the first human operator to position the consumer electronic device in the first orientation relative to the imaging device,
obtain the first image while the consumer electronic device is in the first orientation,
display, via the first display screen, a second prompt instructing the first human operator to position the consumer electronic device in a second orientation relative to the imaging device, the second orientation different than the first orientation, and
obtain a second image of the consumer electronic device while the consumer electronic device is in the second orientation; and
the compensation value is based at least partially on the inspection data and an evaluation of the first and second images by the second human operator.

38. The computing system of claim 32 wherein the first processor is further configured to:
receive, from the second processor, at least a portion of the inspection data,
cause the first display screen to display all or a subset of the received inspection data to the first human operator, and
prompt the first human operator to verify the displayed inspection data.

39. The computing system of claim 32 wherein the first processor is further configured to:
receive, from the second processor, at least a portion of the inspection data,
cause the first display screen to display all or a subset of the received inspection data to the first human operator, and
prompt the first human operator to compare the displayed inspection data to the consumer electronic device to confirm that the displayed inspection data is correct.

40. The computing system of claim 32 wherein the second processor is further configured to electrically inspect the consumer electronic device automatically after the consumer electronic device is connected to the communication component.

41. The computing system of claim 32 wherein the handheld evaluator input device is a mobile computer, wherein the evaluator hub device is a stationary computing device, wherein the device evaluation station includes an evaluator server located remotely from the handheld evaluator input device and the evaluator hub device, and wherein the consumer electronic device is a mobile phone.
